(19) United States
(12) Patent Application Publication
(10) Pub. No.: US 2002/0155040 A1
(43) Pub. Date: Oct. 24, 2002

(54) Exhaust gas purification device for lean-burn engine

(76) Inventors: Masahiro Sakanushi, Wako-shi (JP); Hideki Uedahira, Wako-shi (JP); Hiroshi Oono, Wako-shi (JP); Yoshiaki Matsuzono, Wako-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/122,145

(22) Filed: Apr. 15, 2002

(30) Foreign Application Priority Data
Apr. 19, 2001 (JP) 2001-121181

(51) Int. Cl. B01D 53/34; B01D 53/56; B01D 53/62; B01D 53/72

(52) U.S. Cl. 422/177; 422/170; 422/171

(57) ABSTRACT

An exhaust gas purification device for a lean-burn engine that can be produced at a low cost. The exhaust gas purification device includes a three-way catalyst that, during stoichiometric operation of the engine, removes a lower proportion of CO than the proportion of HC removed. The three-way catalyst is positioned in the device on the upstream side of an exhaust pipe of the lean-burn engine, and a lean NOₓ catalyst is positioned in the device on the downstream side of the exhaust pipe. A perovskite type double oxide is used as the three-way catalyst instead of a precious metal.

### BACKGROUND OF THE INVENTION

The present invention relates to an exhaust gas purification device for a lean-burn engine, and more particularly to an improved exhaust gas purification device including a three-way catalyst that, during the stoichiometric operation, removes a lower proportion of CO than the proportion of HC it removes and that is positioned on the upstream side of the exhaust gas flow of a lean-burn engine and a lean NOₓ catalyst that is positioned on the downstream side of the exhaust gas flow, where stoichiometric operation of the engine means operation at or in the vicinity of the theoretical air-fuel ratio.

As this type of exhaust gas purification device, an exhaust gas purification device using a precious metal as the three-way catalyst has been conventionally known (see, for example, Japanese Patent Application Laid-open No. 11-101125).

A precious metal three-way catalyst having the above-mentioned function is positioned on the upstream side of the exhaust gas flow for the following reason: When NOₓ that has been adsorbed by a lean NOₓ catalyst during lean-bum operation is reduced during stoichiometric operation, the reduction is more effectively carried out by using CO as a reducing agent than by using HC as the agent. Use of the above-mentioned precious metal three-way catalyst suppresses the removal of CO during stoichiometric operation, thereby supplying sufficient CO as a reducing agent to the lean NOₓ catalyst.

However, since the conventional three-way catalyst on the upstream side of the exhaust gas flow is a precious metal three-way catalyst such as a catalyst using expensive Pd, Pt and Rh, the high production cost of the exhaust gas purification device is a significant problem.

### SUMMARY OF THE INVENTION

It is an object of the present invention to provide an exhaust gas purification device that can be produced at a lower cost by using, as a three-way catalyst, materials far less expensive than precious metals.

In order to achieve the above-mentioned object, in accordance with the present invention, there is proposed an improved exhaust gas purification device for a lean-bum engine. The exhaust gas purification device includes a three-way catalyst positioned on the upstream side of an exhaust gas flow of a lean-burn engine, the proportion of CO removed by the three-way catalyst during stoichiometric operation being lower than the proportion of HC removed, and a lean NOₓ catalyst positioned on a downstream side of the exhaust gas flow, wherein the three-way catalyst includes a perovskite type double oxide.

As the perovskite type double oxide which replaces a precious metal three-way catalyst, the perovskite type double oxide has an exhaust gas purification ability which is essentially equivalent to that of the precious metal three-way catalyst. During stoichiometric operation of the lean burn engine, the proportion of CO removed by the perovskite type double oxide is lower than the proportion of HC removed. The device utilizes this difference to provide a reduction of NOₓ by use of CO as a reducing agent.

### BRIEF DESCRIPTION OF DRAWINGS

FIG. 1 is a block diagram of a lean-bum engine and an exhaust gas purification device therefor; and

FIG. 2 is a graph showing the relationship between the air-fuel ratio of an exhaust gas and the exhaust gas purification rate for a perovskite type double oxide.

### DETAILED DESCRIPTION OF THE INVENTION

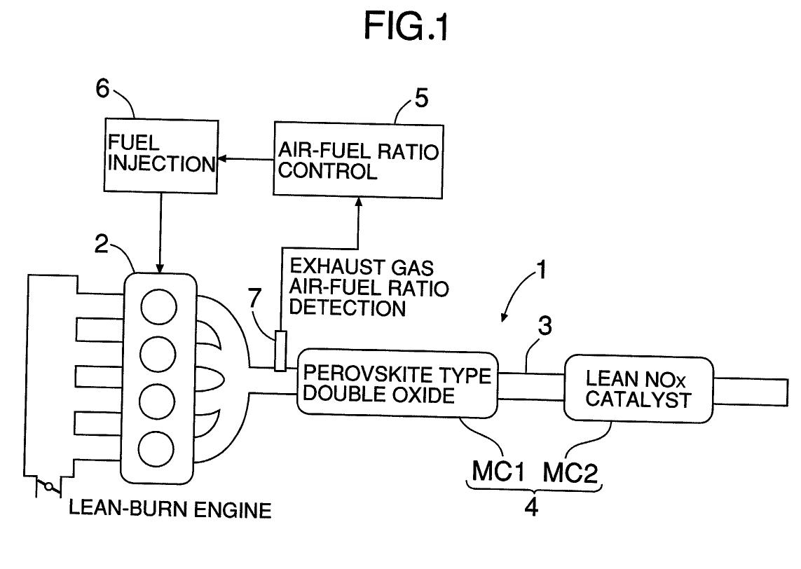

In FIG. 1, an exhaust gas purification system 1 includes an exhaust gas purification device 4 positioned in an exhaust pipe 3 of a lean-bum engine 2, and an air-fuel ratio control device 5 for controlling the air-fuel ratio (A/F) of a gaseous mixture that is supplied to the lean-burn engine 2. A fuel injection device 6 injects into the lean-burn engine 2 an amount of fuel based on a control signal from the air-fuel control device 5.

The exhaust gas purification device 4 includes a first monolithic catalyst MC1 positioned on the upstream side of the exhaust gas flow from engine 2, that is, on the upstream side of the exhaust pipe 3, and a second monolithic catalyst MC2 positioned on the downstream side of the exhaust gas flow, that is, on the downstream side of the exhaust pipe 3. The first monolithic catalyst MC1 contains a perovskite type double oxide that functions as a three-way catalyst, and the second monolithic catalyst MC2 contains a lean NOₓ catalyst.

The perovskite type double oxide of catalyst MC1 is characterized in that, during stoichiometric operation of the lean-burn engine 2, the proportion of CO removed is lower than the proportion of HC removed. The lean NOₓ catalyst may contain Ba, which is an NOₓ adsorber, and the precious metals Pt and Rh.

The exhaust pipe 3 is equipped with an air-fuel ratio sensor (O₂ sensor) 7 on the upstream side of the exhaust gas purification device 4. The air-fuel ratio sensor 7 detects, as an oxygen concentration, the air-fuel ratio of the exhaust gas that is discharged from the lean-burn engine 2 and introduced into the exhaust gas purification device 4, that is, the air-fuel ratio of the gaseous mixture that has been supplied to the lean-burn engine 2. The air-fuel ratio control device 5 controls the air-fuel ratio of the gaseous mixture that is supplied by the fuel injection device 6 to the lean-burn engine 2 based on a signal from the air-fuel ratio sensor 7.

In the above-mentioned arrangement, the air-fuel ratio sensor 7 detects the air-fuel ratio of the gaseous mixture that has been supplied to the lean-burn engine 2, and the detection signal is fed back to the air-fuel ratio control device 5. The air-fuel ratio control device 5 calculates, based on the detection signal, an amount of fuel to be injected so that the air-fuel ratio of the exhaust gas on the upstream side of the exhaust gas purification device 4 equals the theoretical air-fuel ratio, and the thus-calculated amount of fuel is injected by the fuel injection device 6 into the lean-burn engine 2. The lean-bum engine 2 thereby can be operated stoichiometrically, and its exhaust gas is purified by the perovskite type double oxide. In the case where the lean NOₓ catalyst functions as a three-way catalyst, the exhaust gas is also purified by the lean NOₓ catalyst.

When the air-fuel ratio of the exhaust gas is controlled to a dilute mixture ratio, the lean-burn engine 2 conducts a lean-bum operation, and the thus-generated NOₓ contained in the exhaust gas is mainly adsorbed by the lean NOₓ catalyst. The exhaust gas also contains small amounts of CO and HC generated along with the NOₓ, and the CO and HC contribute to the reduction of NOₓ by the perovskite type catalyst.

When the lean-bum engine 2 is operated stoichiometrically in order to reduce the NOₓ that has been adsorbed by the lean NOₓ catalyst, CO and HC in the exhaust gas are removed (oxidized) by the perovskite type double oxide. In this case the amount of CO is reduced by, for example, about 70% and the amount of HC is reduced by, for example, about 90%. As a result, a CO-rich exhaust gas is supplied to the lean NOₓ catalyst, thereby carrying out an effective reduction of NOₓ.

Preferred perovskite type double oxides represented by the general formula Aₐ₋ₓBₓMO_{b}, where A denotes a lanthanide mixture that has been extracted from bastnasite; B denotes a mono-valent or di-valent cation; M denotes at least one element selected from the group consisting of elements having an atomic number in the range of 22 to 30, 40 to 51 and 73 to 80; a is 1 or 2, b is 3 when a is 1 and b is 4 when a is 2; and 0 #x<0.7. It is preferable to use a lanthanide mixture that has been extracted from bastnasite. Preferably, B is selected from K, Ca and Sr and M is selected from Mn, Co, Cr, Fe, Ni, Ru and Cu.

Examples of the perovskite type double oxide include Ln_{0.6}Ca_{0.4}CoO₃ (Ln denotes a lanthanide and includes one or more of elements 57-71, that is, La, Ce, Pr, Nd, etc.; the same applies below), Ln_{0.83}Sr_{0.17}MnO₃, Ln_{0.7}Sr_{0.3}CrO₃, Ln_{0.6}Ca_{0.4}Fe_{0.8}Mn_{0.2}O₃, Ln_{0.8}Sr_{0.2}Mn_{0.9}Ni_{0.04}Ru_{0.06}O₃, Ln_{0.8}K_{0.2}Mn_{0.95}Ru_{0.05}O₃, Ln_{0.7}Sr_{0.3}Cr_{0.95}Ru_{0.05}O₃, LnNiO₃, Ln₂(Cu_{0.6}Co_{0.2}Ni_{0.2})O₄, and Ln_{0.8}K_{0.2}Mn_{0.95}Ru_{0.05}O₃.

Such perovskite type double oxides are disclosed in the published Japanese translation of PCT application No. 2000-515057 (Specification and Drawings of International Patent Application Laid-open WO 97/37760) incorporated herein by reference, and the oxides disclosed therein can be used in the present invention. The above-mentioned air-fuel ratio control device 5 is disclosed in Japanese Patent Application Laid-open No. 60-1342, which is an application by the present inventor, and the electronic control unit 5 disclosed therein can be used in conjunction with the present invention.

More specifically, the first monolithic catalyst MC1 is produced by carrying the perovskite type double oxide Ln_{0.83}Sr_{0.17}MnO₃ obtained in accordance with Example 5 of the published Japanese translation of PCT application No. 2000-515057, on 0.7 L of a honeycomb support so as to give a BET specific surface area of 9.3 m²/g.

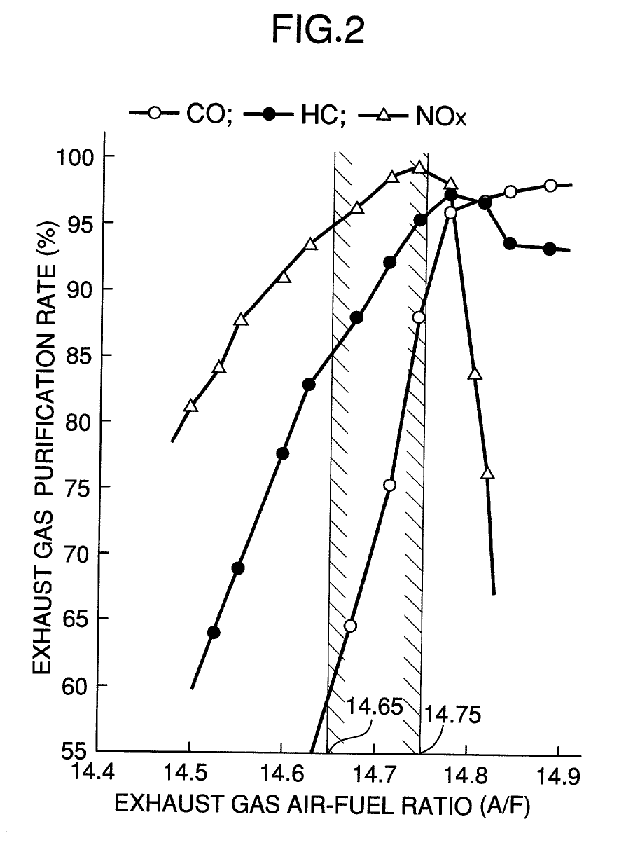

FIG. 2 shows the relationship between the exhaust gas air-fuel ratio A/F and the degree of purification of the exhaust gas for the perovskite type double oxide Ln_{0.83}Sr_{0.17}MnO₃. The theoretical air-fuel ratio A/F in this case is 14.7, and said vicinity thereof refers to, for example, on either side of A/F=14.7, A/F=14.65 to A/F=14.75. It can be seen from FIG. 2 that there is a difference between the proportion of CO removed and the proportion of HC removed in the above-mentioned stoichiometric operation range.

Used as the second monolithic catalyst MC2 may be known catalyst structure such as, for example, a catalyst structure comprising a honeycomb support supporting a catalyst layer comprising a lower layer and an upper layer. In this case, the lower sublayer is formed from a catalyst in which Pt and Ba (NOₓ adsorber) are carried on alumina and ceria, and the upper sublayer is formed from a catalyst in which Pt, Rh and Ba are carried on a zeolite.

Incorporating the above-mentioned first and second monolithic catalysts MC1 and MC2 into the exhaust gas purification device 4 of the lean-burn engine 2 can achieve an exhaust gas purification rate that is equivalent to known examples such as that disclosed in Japanese Patent Application Laid-open No. 11-101125.

In accordance with the present invention, since a perovskite type double oxide is used as a three-way catalyst positioned on the upstream side of the exhaust gas flow, it is possible to provide an exhaust gas purification device for a lean-burn engine that can be produced at a low cost compared with the conventional device using a precious metal three-way catalyst.

It is claimed:

1. An exhaust gas purification device for an exhaust gas flow from a lean-burn engine, the device comprising:
a three-way catalyst positioned on an upstream side of the exhaust gas flow, the proportion of CO removed by the three-way catalyst during stoichiometric operation being lower than the proportion of HC removed; and
a lean NOₓ catalyst positioned on a downstream side of the exhaust gas flow;
wherein the three-way catalyst comprises a perovskite double oxide.

2. An exhaust gas purification device according to claim 1, wherein the lean NOₓ catalyst contains Ba as an NOₓ adsorber and the metals Pt and Rh.

3. An exhaust gas purification device according to claim 1, wherein the perovskite double oxide is represented by the general formula Aₐ₋ₓBₓMO_{b}, where A denotes a lanthanide mixture; B denotes a mono-valent or di-valent cation; M denotes at least one element selected from the group consisting of elements having an atomic number in the range of 22 to 30, 40 to 51 and 73 to 80; a is 1 or 2, b is 3 when a is 1 and b is 4 when a is 2; and 0 #x<0.7.

4. An exhaust gas purification device according to claim 3, wherein the lean NOₓ catalyst contains Ba as an NOₓ adsorber and the metals Pt and Rh.

5. An exhaust gas purification device according to claim 3, wherein B of the perovskite double oxide is selected from the group consisting of K, Ca and Sr.

6. An exhaust gas purification device according to claim 5, wherein M of the perovskite double oxide is selected from the group consisting of Mn, Co, Cr, Fe, Ni, Ru and Cu.

7. An exhaust gas purification device according to claim 6, wherein the lean NOₓ catalyst contains Ba as an NOₓ adsorber and the metals Pt and Rh.

8. An exhaust gas purification device according to claim 3, wherein the lanthanide mixture has been extracted from bastnasite.

9. An exhaust gas purification device according to claim 5, wherein the lanthanide mixture has been extracted from bastnasite.
